(19) United States
(12) Patent Application Publication
(10) Pub. No.: US 2024/0193523 A1
(43) Pub. Date: Jun. 13, 2024

(54) VIRTUAL CAREER MENTOR THAT CONSIDERS SKILLS AND TRAJECTORY

(71) Applicant: International Business Machines Corporation, Armonk, NY (US)

(72) Inventors: Fearghal O'Donncha, Aran Islands (IE); Paulito Palmes, Dublin (IE); Albert Akhriev, Dublin (IE); Amadou Ba, Navan (IE)

(21) Appl. No.: 18/063,101

(22) Filed: Dec. 8, 2022

(51) Int. Cl. G06Q 10/06

(52) U.S. Cl. CPC G06Q 10/0639; G06Q 10/06311

(57) ABSTRACT

In an approach for a virtual assistant career mentor that provides a user with personalized career recommendations, a processor identifies a position a user wishes to achieve in a request for a personalized career recommendation. A processor compares a user profile of the user to a marketplace profile for the position to determine whether there are one or more gaps in the user profile that would prevent the user from achieving the position. Responsive to determining there is a gap in the user profile, a processor assigns the user a task to address the gap in the user profile. A processor generates a performance score using a reinforcement learning model. Responsive to updating the user profile with the performance score, a processor generates a recommendation using machine learning, wherein the recommendation includes a series of actions the user may take to achieve the position identified and an appropriate timeline.

### BACKGROUND OF THE INVENTION

The present invention relates generally to the field of virtual assistants, and more particularly to a virtual assistant career mentor that considers skills and trajectory of a user to help the user navigate decision making.

Gamification or virtual simulations of a task is an assignment of a task to a person that mimics specific aspects of the person's job role or related real-world task. The assignment of the task to the person may be done automatically (e.g., from a database of tasks) based on one or more recommendations. The recommendation may be generated by an Artificial Intelligent (AI) algorithm.

Reinforcement learning is an unsupervised learning model that uses the Markov Decision Process to determine how intelligent agents ought to take action in an environment in order to maximize a reward.

### SUMMARY

Aspects of an embodiment of the present invention disclose a method, computer program product, and computer system for a virtual assistant career mentor that provides a user with personalized career recommendations. A processor identifies a position a user wishes to achieve in a request for a personalized career recommendation. A processor compares a user profile of the user to a marketplace profile for the position to determine whether there are one or more gaps in the user profile that would prevent the user from achieving the position. Responsive to determining there is a gap in the user profile, a processor assigns the user a task to address the gap in the user profile. A processor generates a performance score using a reinforcement learning model, wherein the performance score is based on an evaluation of the user completing the task. Responsive to updating the user profile with the performance score, a processor generates a recommendation using machine learning, wherein the recommendation includes a series of actions the user may take to achieve the position identified and an appropriate timeline.

In some aspects of an embodiment of the present invention, prior to identifying the position the user wishes to achieve in the request for the personalized career recommendation, a processor gathers a set of information about the user. A processor creates the user profile with the set of information about the user.

In some aspects of an embodiment of the present invention, the set of information about the user is a set of information about a current state of the user, and wherein the set of information about the user includes at least one of a set of information about an employment history of the user, one or more relevant job skills of the user, an educational and training history of the user, one or more preferences of the user, one or more passions of the user, and one or more purposes of the user.

In some aspects of an embodiment of the present invention, subsequent to identifying the position the user wishes to achieve in the request for the personalized career recommendation, a processor gathers a set of information about a state of educational requirements for the position. A processor gathers a set of information about a state of a workplace. A processor gathers a set of information about one or more available positions. A processor creates the marketplace profile for the position with the set of information about the state of educational requirements for the position, the set of information about the state of the workplace, and the set of information about the one or more available positions.

In some aspects of an embodiment of the present invention, the set of information about the state of educational requirements for the position includes at least one of one or more requirements of university courses, one or more demands of the university courses, and one or more ratings given to the university courses; the set of information about the state of the workplace includes a set of information about a job market; and the set of information about the one or more available positions includes at least one of one or more requirements of the one or more available positions and one or more profiles of one or more candidates for the one or more available positions.

In some aspects of an embodiment of the present invention, the assignment of the task is based on an information criterion, and wherein the information criterion is at least one of an Akaike information criterion or a Schwarz information criterion.

In some aspects of an embodiment of the present invention, the task includes at least one of an additional educational qualification the user needs to earn, an additional massive open online course the user needs to complete, an additional technical skill the user needs to develop, an additional soft skill the user needs to develop, an additional industry experience the user needs to gain, and a greater external eminence the user needs to achieve.

In some aspects of an embodiment of the present invention, subsequent to generating the performance score using the reinforcement learning model, a processor updates the user profile to include the task completed and the performance score generated.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps of a virtual mentorship program, on a server within the distributed data processing environment of FIG. 1, in accordance with an embodiment of the present invention; and

FIG. 3 depicts a block diagram of components of a computing environment representing the distributed data processing environment of FIG. 1, in accordance with an embodiment of the present invention.

### DETAILED DESCRIPTION

Embodiments of the present invention recognize that the need for career coaching and mentoring can be recognized as early as high school or undergraduate level. For example, a senior at the high school or undergraduate level may be struggling through their college or graduate school applications because the senior is aiming to craft the perfect profile to fit the criterion of their dream school too late in the process. Embodiments of the present invention also recognize that the need for career coaching and mentoring extends beyond one's high school or undergraduate level and continues throughout one's career. Embodiments of the present invention, however, recognize that career coaching and mentoring can be challenging because employees are changing jobs more frequently and because industries are also rapidly changing. Simultaneously, an employee's career trajectory is becoming increasingly characterized by data, including information related to the employee's educational achievements (e.g., university qualifications, diplomas, and certificates achieved), external eminence (e.g., professional body memberships and conference speaking activities), preferences for digital media sources (e.g., Netflix®, Facebook®, Udemy®, Coursera®), and other dimensions (e.g., passions, purposes, and motivations). Therefore, embodiments of the present invention recognize the need for a system and method to actively incorporate the data characterizing the employee's career trajectory in career recommendations personalized to meet specified or implicit career objectives of the employee.

Embodiments of the present invention provide a system and method for a virtual assistant career mentor that provides a user with personalized career recommendations (e.g., actionable advice and feedback). The system and method use a gamification (or a virtual task) module, together with a machine learning module to help the user meet specified or implicit career objectives. The system and method start with an outline of a position (e.g., C-level, executive, medical consultant, university professor) the user wishes to achieve. The system and method then gather a variety of information about the user as inputs (e.g., educational achievements, external eminence, preferences for digital media sources, and other dimensions) to create a user profile. The system and method compare the user profile to a marketplace profile (i.e., a profile that may include, but is not limited to, the available positions, requirements of the available positions, the current state of the workplace, the trends in the job marketplace, and the current state of educational requirements) to identify gaps in the user profile. If there are one or more gaps in the user profile, the system and method invoke the gamification (or the virtual task) module and assigns one or more tasks to the user. The gamification (or the virtual task) module evaluates the user's performance of the one or more tasks to augment the profile. The system and method provide the information gathered from the user's performance of the one or more tasks to the machine learning module. The machine learning module compares the user profile to a profile of a person in the desired position the user wishes to achieve (e.g., medical consultant) and defines a career trajectory to achieve the user's desired position (e.g., additional educational qualifications that the user needs to earn, additional massive open online courses (MOOC) that the user needs to complete, additional technical skills (e.g., learning a particular coding task) and/or soft skills that the user needs to develop (e.g., improving the user's public speaking skills), additional industry experience that the user needs to gain (e.g., opportunity cost of an unpaid internship at a well-known company versus a high paid internship at a lesser known company in a lower position), and greater external eminence that the user needs to achieve). Using a given tuple or array of the current state of the user (i.e., education, career, skills, . . . ), the machine learning module defines an optimal succession of actions (i.e., a series of state transitions the user may take to achieve the user's desired position (e.g., recommendations on future jobs to achieve the career trajectory and an appropriate timeline)). The optimal succession of actions forms the career trajectory of the user.

Gamification or virtual simulations of a task is an assignment of a task to a person that mimics specific aspects of the person's job role or related real-world task. The assignment of the task to the person may be done automatically (e.g., from a database of tasks) based on one or more recommendations. The recommendation may be generated by an Artificial Intelligent (AI) algorithm.

Reinforcement learning is an unsupervised learning model that uses the Markov Decision Process to determine how intelligent agents ought to take action in an environment in order to maximize a reward. Reinforcement learning consists of a state space S, an action space A, and a set of possible rewards where the reward R at time t E T indicates how good an action and/or intervention taken was (e.g., in the short term, long term, or both). In an embodiment relevant to the present invention, the state space S may be where each state considers metrics such as education_{1 . . . x}, career_{1 . . . y}, skills_{1 . . . z}, personal_{1 . . . z}, measured at time t. Some aspects of the state space S also consider the results of gamification or virtual tasks completed by the user. The action space A is where each action A represents an intervention by a decision-making agent and/or controller. Aspects considered for action space A may include, but are not limited to, an additional job role responsibility (e.g. job promotion or increase in an assigned portfolio), an additional online certification (e.g. OpenShift® developer certification), or an increased external eminence (e.g. professional body certification). Aspects considered for action space A also include the performance or completion of gamified or virtual tasks, and the score or performance level achieved on the gamified or virtual tasks.

Implementation of embodiments of the present invention may take a variety of forms, and exemplary implementation details are discussed subsequently with reference to the Figures.

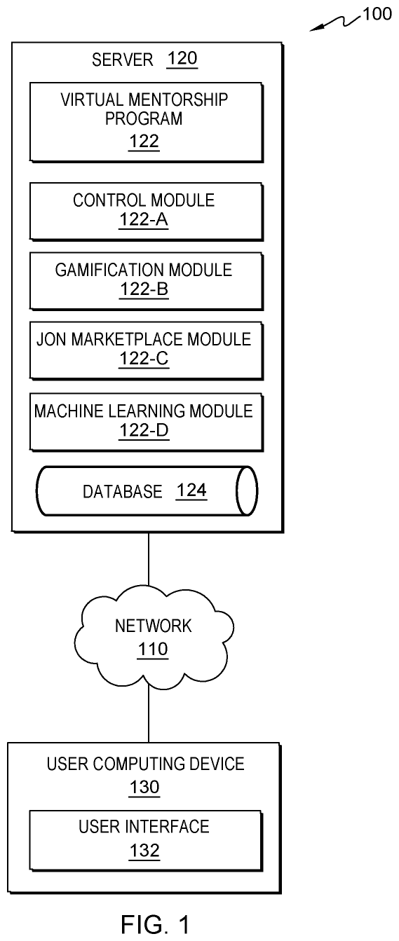

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120 and user computing device 130, and other computing devices (not shown) within distributed data processing environment 100.

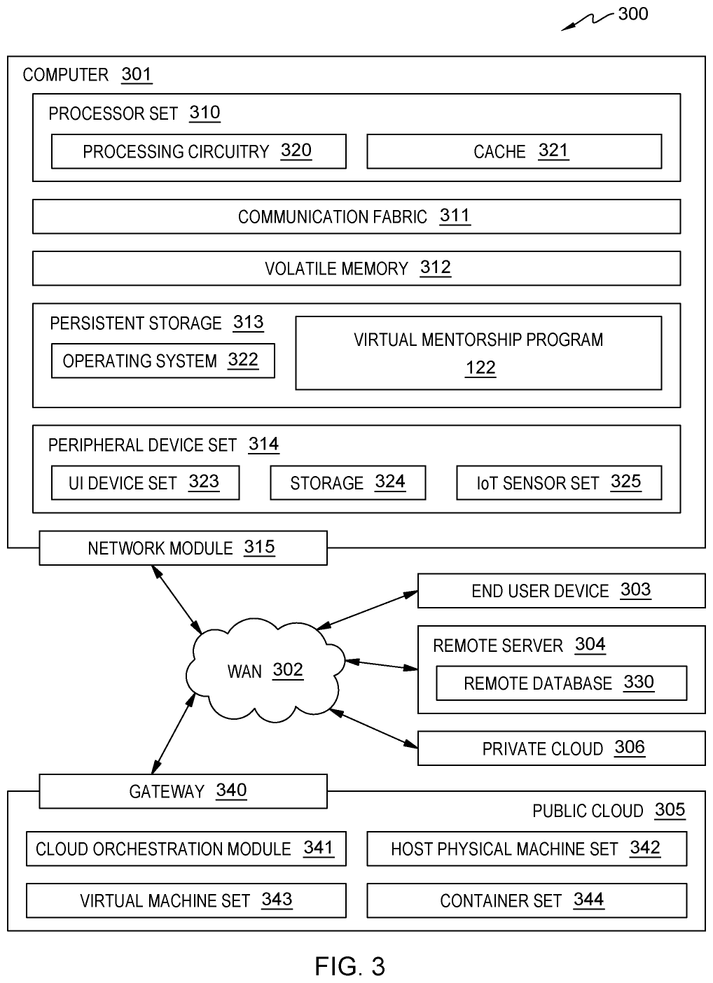

Server 120 operates to run virtual mentorship program 122 and to send and/or store data in database 124. In an embodiment, server 120 can send data from database 124 to user computing device 130. In an embodiment, server 120 can receive data in database 124 from user computing device 130. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 3.

Virtual mentorship program 122 operates to combine gamification (or virtual tasks) and machine learning to provide a user with personalized career recommendations (e.g., actionable advice and feedback). In the depicted embodiment, virtual mentorship program 122 is a standalone program. In another embodiment, virtual mentorship program 122 may be integrated into another software product. In the depicted embodiment, virtual mentorship program 122 resides on server 120. In another embodiment, virtual mentorship program 122 may reside on another computing device (not shown), provided that virtual mentorship program 122 has access to network 110.

In the depicted embodiment, virtual mentorship program 122 contains control module 122-A, gamification module 122-B, job marketplace module 122-C, and machine learning module 122-D. Control module 122-A operates to collect information on user preferences from sources such as digital media (i.e., social media platforms and websites), educational achievements of a user (e.g., university qualifications, diplomas, and certificates achieved), external eminence (e.g. professional body memberships and conference speaking activities) and other dimensions of the user (e.g., passions, purposes, and motivations). Gamification module 122-B operates to assign one or more tasks to the user and to generate a performance score for the one or more tasks completed. Job marketplace module 122-C operates to characterize the job market (e.g., recruitment firm analysis, employment figures, and future jobs indicators), future trends (e.g. emerging technologies such as quantum computing and changing job skill demands in a hybrid work environment), and to identify the key skills and competencies exhibited by people in these roles. Machine learning module 122-D operates to process the data and make recommendations to the user on how to achieve desired outcomes or goals and to evaluate how changes to the user profile (e.g., obtaining new skills or competencies, obtaining new job responsibilities, and obtaining new professional body memberships or certifications) impacts suitability towards a desired job or role (i.e., impacts on the reward).

Machine learning module 122-D of virtual mentorship program 122 may be a reinforcement learning algorithm based on a Markov Decision Process (MDP). A MDP is a mathematical model of sequential decisions and a dynamic optimization method. A MDP consists of the following five elements: {T, S, A, p, r}, where 1) T is all decision time sets; 2) S is a set of countable nonempty states, which is a set of all possible states of the system; 3) A is a set of all possible decision-making behaviors when the system is in a given state; 4) p is the probability of moving to state j when the system is in state i∈S and the decision-making behavior α∈A(i) is taken (i.e., Σ_{j∈S} as p(j|i, a)=1); and 5) r=r (i, α) is a reward function, which represents the expected reward obtained when the system is in a state i∈S at any time and adopts a decision-making behavior α∈A(i). In another embodiment, machine learning module 122-D may also represent the extraction of measurable key performance indicators from control module 122-A, gamification module 122-B, and job marketplace module 122-C. The data may be processed by machine learning module 122-D and a reputation score may be computed for the user based on relative performance against peers.

Machine learning module 122-D of virtual mentorship program 122 may be a MDP-type algorithm based on the following assumptions: 1) there exists a model of the real-world environment from which a decision agent can take some action and the model generates a transition from one state to another state as a result of the action taken: (state, action)->next-state and 2) the model can estimate reward or loss by training machine learning to learn the mapping: (state, action) which maximizes the reward function or reputation score. The Action Space represents the environment where the decision agent can take action. The Action Space may be defined as education | career | skills | personal | . . . and the State Space may be defined as (education_{1 . . . x}, career_{1 . . . y}, skills_{1 . . . z}, personal_{1 . . . z}, . . . ). The reputation score may be a combined metric that reflects the performance of the user on multiple dimensions such as education, professional experience, demonstration of technical knowledge, external eminence, etc. With the given transition and reward functions, any machine learning agent can explore state transitions by exploring the Action Space and find the optimal policy of actions based on the computed accumulated reward. The optimal policy of actions can be used to generate optimal trajectory from the current state (i.e., the current role) to the target state (i.e., the career trajectory). This allows the system to make recommendations to the user related to the potential value of different career choices (e.g., job role change, further education, professional certification, etc.).

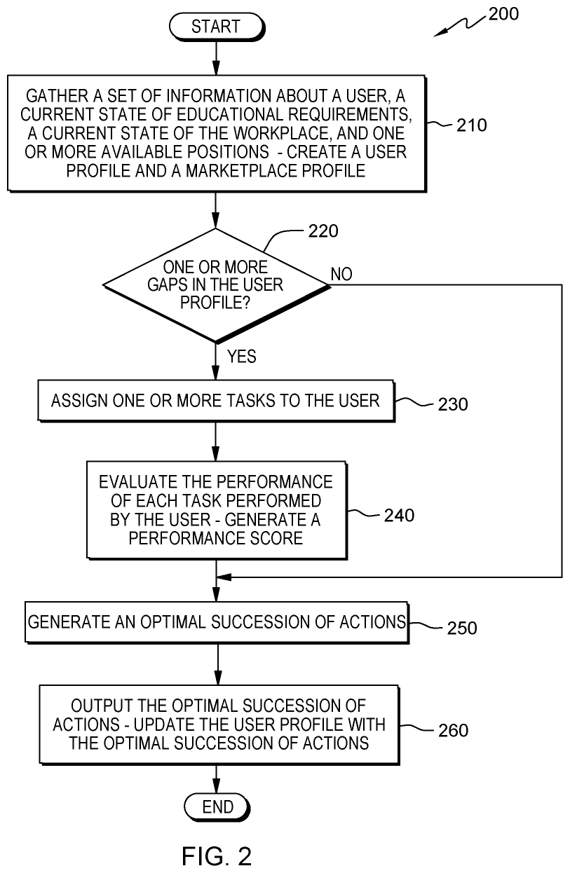

In an embodiment, the user of user computing device 130 registers with virtual mentorship program 122 of server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via virtual mentorship program 122). Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124. The operational steps of virtual mentorship program 122 are depicted and described in further detail with respect to FIG. 2.

Database 124 operates as a repository for data received, used, and/or generated by virtual mentorship program 122. A database is an organized collection of data. Data includes, but is not limited to, information about user preferences (e.g., general user system settings such as alert notifications for user computing device 130); information about alert notification preferences; information about job marketplace datapoints (e.g. distribution of open positions in an industry; highly-sought skills in an industry); information about gamification tasks (e.g. list of virtual tasks that can be assigned to a user, performance score of the user on a given virtual task); and any other data received, used, and/or generated by virtual mentorship program 122.

Database 124 can be implemented with any type of device capable of storing data and configuration files that can be accessed and utilized by server 120, such as a hard disk drive, a database server, or a flash memory. In an embodiment, database 124 is accessed by virtual mentorship program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that virtual mentorship program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Virtual mentorship program 122 enables the authorized and secure processing of personal data.

Virtual mentorship program 122 provides informed consent, with notice of the collection of personal and/or confidential data, allowing the user to opt-in or opt-out of processing personal and/or confidential data. Consent can take several forms. Opt-in consent can impose on the user to take an affirmative action before personal and/or confidential data is processed. Alternatively, opt-out consent can impose on the user to take an affirmative action to prevent the processing of personal and/or confidential data before personal and/or confidential data is processed. Virtual mentorship program 122 provides information regarding personal and/or confidential data and the nature (e.g., type, scope, purpose, duration, etc.) of the processing. Virtual mentorship program 122 provides the user with copies of stored personal and/or confidential company data. Virtual mentorship program 122 allows the correction or completion of incorrect or incomplete personal and/or confidential data. Virtual mentorship program 122 allows for the immediate deletion of personal and/or confidential data.

User computing device 130 operates to run user interface 132 through which a user can interact with virtual mentorship program 122 on server 120. In an embodiment, user computing device 130 are each a device that performs programmable instructions. For example, user computing device 130 may each be an electronic device, such as a laptop computer, a tablet computer, a netbook computer, a personal computer, a desktop computer, a smart phone, or any programmable electronic device capable of running the respective user interface 132 and of communicating (i.e., sending and receiving data) with virtual mentorship program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between virtual mentorship program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from virtual mentorship program 122 to a user via network 110. User interface 132 can also display or present alerts including information (such as graphics, text, and/or sound) sent from virtual mentorship program 122 to a user via network 110. In an embodiment, user interface 132 can send and receive data (i.e., to and from virtual mentorship program 122 via network 110, respectively). Through user interface 132, a user can opt-in to virtual mentorship program 122; input a request for personalized career recommendations; input information about the user; create a user profile; set user preferences and alert notification preferences; receive one or more tasks; complete the one or more tasks; receive a suggestion of an alternative position and/or alternative career to the desired position the user wishes to achieve; receive an optimal succession of actions; receive a request for feedback; and input feedback.

A user preference is a setting that can be customized for a particular user. A set of default user preferences are assigned to each user of virtual mentorship program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of virtual mentorship program 122.

FIG. 2 is a flowchart, generally designated 200, illustrating the operational steps for virtual mentorship program 122, on server 120 within distributed data processing environment 100 of FIG. 1, in accordance with an embodiment of the present invention. In an embodiment, virtual mentorship program 122 operates to combine gamification (or virtual tasks) and machine learning to provide a user with personalized career recommendations (e.g., actionable advice and feedback). It should be appreciated that the process depicted in FIG. 2 illustrates one possible iteration of the process flow, which may be repeated each time a user inputs a request for personalized career recommendations to achieve a desired position through a user interface (e.g., user interface 132) of a user computing device (e.g., user computing device 130).

For example, user A is a thirty-year old marketing specialist. User A lives in London, England. User A is a digital native (i.e., a person born or brought up during the age of digital technology and therefore familiar with computers and the internet from an early age) and can be described as ambitious and detail focused. User A likes her current job as a marketing specialist but would like to have a more defined career path. Eventually, user A wants to undertake greater leadership roles and increase her eminence. More specifically, user A's three-, five-, and ten-year goals are to progress to a marketing manager role, to a director role, and to a vice president role, respectively. User A discussed her career path with her manager. However, user A is not satisfied with the outcome of her conversation with her manager. Her conversations left her confused about the opportunities she could pursue and the specific skills, capabilities, and expertise she lacks to achieve her career objectives. User A is also not satisfied with the outcome of her conversations with her manager because her manager did not provide her with specific action-oriented feedback (i.e., specific steps she can take to progress her career). User A inputs a request to virtual mentorship program 122 for personalized career recommendations to achieve her career objectives through a user interface (e.g., user interface 132) of a user computing device (e.g., user computing device 130).

In step 210, control module 122-A of virtual mentorship program 122 gathers a set of information about the user. In an embodiment, control module 122-A of virtual mentorship program 122 enables the user to input a set of information through a user interface (e.g., user interface 132) of a user computing device (e.g., user computing device 130). In another embodiment, control module 122-A of virtual mentorship program 122 gathers a set of information about the user from one or more online media sources (i.e., social media platforms and websites). In another embodiment, control module 122-A of virtual mentorship program 122 gathers a set of information about the user from a questionnaire and/or a psychometric test (e.g., Hermann Brain Dominance Instrument®). The set of information about the user is a set of information about a current state of the user. The set of information about the user may include, but is not limited to, information about an employment history of the user (e.g., a current job experience, a previous job experience), one or more relevant job skills of the user, an educational and training history of the user (e.g., courses completed, certifications recognized, accreditations earned, eminence awards presented), one or more preferences of the user (i.e., preferences of specific online media sources, and one or more passions, purposes, and/or motivations of the user). The set of information about the user is defined in a tuple or an array (e.g., education₁, career₁, skills₁, personal₁, . . . ), wherein each element of the tuple can be a tuple itself (e.g., education=(subject₁, subject₂, . . . ). In an embodiment, control module 122-A of virtual mentorship program 122 identifies the desired position the user wishes to achieve in the request for personalized career recommendations. In an embodiment, control module 122-A of virtual mentorship program 122 creates a user profile with the set of information about the user. In an embodiment, control module 122-A of virtual mentorship program 122 stores the user profile in a database (e.g., database 124).

In continuation of the example above, virtual mentorship program 122 creates a user profile for user A. Virtual mentorship program 122 includes in the user profile information regarding user A, including, but not limited to, user A's career objectives (e.g., three-, five-, and ten-year goals), user A's current and previous job experiences, user A's relevant job skills, user A's education and training, and user A's passion and purpose (e.g., results from a questionnaire and/or a psychometric test completed by user A (e.g., Hermann Brain Dominance Instrument®)).

In an embodiment, control module 122-A of virtual mentorship program 122 gathers a set of information about a current state of educational requirements for the desired position the user wishes to achieve from job marketplace module 122-C. The set of information about the current state of educational requirements for the desired position the user wishes to achieve may include, but are not limited to, one or more requirements of university courses, one or more demands of the university courses, and one or more ratings given to the university courses. Herein, current refers to the present time (i.e., the time when virtual mentorship program 122 processes the user's request for personalized career recommendations).

In an embodiment, control module 122-A of virtual mentorship program 122 gathers a set of information about a current state of the workplace from job marketplace module 122-C (e.g., from Gartner reports). The set of information about the current state of the workplace may include, but is not limited to, information about the current job market and information about the future job market (i.e., future trends, e.g., recruitment firm analysis, employment figures, future job indicators). Herein, current refers to the present time (i.e., the time when virtual mentorship program 122 processes the user's request for personalized career recommendations). Future refers to the time still to come (i.e., the time following virtual mentorship program 122 processing the user's request for personalized career recommendations).

In an embodiment, control module 122-A of virtual mentorship program 122 gathers a set of information about one or more available positions (i.e., similar to the desired position the user wishes to achieve) from job marketplace module 122-C. The set of information about the one or more available positions may include, but is not limited to, one or more requirements of the one or more available positions (i.e., experience(s) and/or skill(s) identified through a keyword analysis, e.g., government initiatives identifying skills required, e.g., science, technology, engineering, and mathematics (STEM)) and one or more profiles of one or more candidates for the one or more available positions (e.g., experience and/or skills possessed by the candidates).

In an embodiment, control module 122-A of virtual mentorship program 122 identifies trends in the job marketplace. In an embodiment, control module 122-A of virtual mentorship program 122 extracts specific requirements (e.g., skills and characteristics required) from the set of information. In an embodiment, control module 122-A of virtual mentorship program 122 creates a marketplace profile with the sets of information (i.e., a profile that may include, but is not limited to, the available positions, requirements of the available positions, the current state of the workplace, the trends in the job marketplace, and the current state of educational requirements).

In continuation of the example above, virtual mentorship program 122 gathers a set of information about jobs in the marketing space from job marketplace module 122-C. The set of information includes experience and skills required to apply for the jobs in the marketing space.

In decision step 220, machine learning module 122-D of virtual mentorship program 122 processes the sets of information stored in the user profile (i.e., in relation to the marketplace profile). In an embodiment, machine learning module 122-D of virtual mentorship program 122 compares the sets of information stored in the user profile to the marketplace profile (e.g., compares the user profile to a user profile of a person in the desired position the user wishes to achieve). In an embodiment, machine learning module 122-D of virtual mentorship program 122 may identify features of the user profile and the marketplace profile that differ. The features may relate to qualification(s), experience(s), skill(s), abilities, and characteristic(s) necessary and/or recommended to achieve the desired position. In an embodiment, machine learning module 122-D of virtual mentorship program 122 determines whether there are one or more gaps in the user profile. If machine learning module 122-D of virtual mentorship program 122 determines there is one or more gaps in the user profile (decision step 220, YES branch), then machine learning module 122-D of virtual mentorship program 122 proceeds to step 230, invoking gamification module 122-B of virtual mentorship program 122 and assigning one or more tasks to the user. If machine learning module 122-D of virtual mentorship program 122 determines there are no gaps in the user profile (decision step 220, NO branch), then machine learning module 122-D of virtual mentorship program 122 proceeds to step 250, generating an optimal succession of actions.

In step 230, responsive to determining there is one or more gaps in the user profile, control module 122-A of virtual mentorship program 122 invokes gamification module 122-B of virtual mentorship program 122. In an embodiment, gamification module 122-B of virtual mentorship program 122 assigns one or more tasks to the user. Each task of the one or more tasks addresses a gap of the one or more gaps found in the user profile. The one or more gaps found in the user profile may prevent the user from achieving the desired position. The purpose of completing a task is to help the user create a more complete profile so that the user can achieve the desired position. The one or more tasks may be assigned to the user from a database of virtual tasks. The assignment of the one or more tasks may be based on an information criterion, such as Akaike information criterion or Schwarz information criterion. A task may include, but is not limited to, additional educational qualifications that the user needs to earn, additional massive open online courses (MOOC) that the user needs to complete, additional technical skills (e.g., learning a particular coding task) and/or soft skills that the user needs to develop (e.g., improving the user's public speaking skills), additional industry experience that the user needs to gain (e.g., opportunity cost of an unpaid internship at a well-known company versus a high paid internship at a lesser known company in a lower position), and greater external eminence that the user needs to achieve. For example, gamification module 122-B of virtual mentorship program 122 assigns the user a coding task relating to Microsoft Excel® (e.g., Pivot tables). In another example, gamification module 122-B of virtual mentorship program 122 assigns the user a coding task relating to Python® (e.g., clustering, regression, sorting). In another example, gamification module 122-B of virtual mentorship program 122 assigns the user a task to improve the user's communication skills. The task is to write a blog post on a given topic. In another example, gamification module 122-B of virtual mentorship program 122 assigns the user a task to improve the user's communication skills. The task is to create an integrated social media strategy.

In another embodiment, gamification module 122-B of virtual mentorship program 122 suggests an alternative position to the desired position the user wishes to achieve. In an embodiment, gamification module 122-B of virtual mentorship program 122 suggests an alternative position (i.e., a different position in the same field or a similar field) during the creating and/or updating process of the user profile. In another embodiment, gamification module 122-B of virtual mentorship program 122 suggests an alternative position during the career mentoring process. For example, gamification module 122-B of virtual mentorship program 122 suggests a psychometric test as part of the creation of the user profile.

In another embodiment, gamification module 122-B of virtual mentorship program 122 suggests an alternative career to the desired position the user wishes to achieve. In an embodiment, gamification module 122-B of virtual mentorship program 122 suggests an alternative career (i.e., a different position in a different field) during the creating and/or updating process of the user profile. In another embodiment, gamification module 122-B of virtual mentorship program 122 suggests an alternative career during the career mentoring process. For example, gamification module 122-B of virtual mentorship program 122 suggests completing a Coursera® course to improve career progression opportunities.

In continuation of the example above, virtual mentorship program 122 identifies specific gaps in the user profile of user A after a comparison of the user profile to the marketplace profile. The specific gaps relate to hard skills, soft skills, and expertise that user A is missing. Namely, user A lacks advanced market analyst skills, and her demonstratable communication skills are weaker than others in the desired position user A wishes to achieve. Virtual mentorship program 122 further evaluates the identified gaps using gamification module 122-B. Gamification module 122-B assigns a task to user A from a database of tasks. Namely, gamification module 122-B assigns user A the task of writing a blog post on a given topic.

In step 240, gamification module 122-B of virtual mentorship program 122 enables the user to complete each task of the one or more tasks assigned. In some embodiment, gamification module 122-B of virtual mentorship program 122 enables the user to complete each task of the one or more tasks assigned through a user interface (e.g., user interface 132) of a user computing device (e.g., user computing device 130). In an embodiment, gamification module 122-B of virtual mentorship program 122 evaluates the performance of each task by the user. In an embodiment, gamification module 122-B of virtual mentorship program 122 generates a performance score (i.e., a quantitative metric). The performance score may be, but is not limited to, a gaming score awarded to the user each time the user exhibits a particular skill. In an embodiment, gamification module 122-B of virtual mentorship program 122 updates the user profile to include the task completed and the performance score awarded for the task completed.

In an embodiment, gamification module 122-B of virtual mentorship program 122 provides control module 122-A of virtual mentorship program 122 with the performance score awarded for the task completed. The performance score awarded for the task completed is returned to control module 122-A of virtual mentorship program 122 because the control module 122-A of virtual mentorship program 122 seeks more granular information on the user. With more granular information, control module 122-A of virtual mentorship program 122 can improve future recommendations (e.g., focus on more remedial skills, suggest alternative career trajectories, etc.).

In continuation of the example above, virtual mentorship program 122 returns performance metrics on assigned tasks to control module 122-A. The performance metrics provide more granular information on user A.

In step 250, machine learning module 122-D of virtual mentorship program 122 generates an optimal succession of actions. The optimal succession of actions is a series of state transitions the user may take to achieve the user's desired position (e.g., recommendations on future jobs to achieve one or more possible career trajectories and an appropriate timeline). The optimal succession of actions is generated from the score (i.e., computed in step 240). The optimal succession of actions is defined in a tuple or an array (e.g., (education₁, career₁, skills₁, . . . ), (education₂, career₂, skills₂, . . . ), (education₃, career₃, skills₃, . . . ), . . . (educationₙ, careerₙ, skillsₙ, . . . ), wherein each element of the tuple can be a tuple itself (e.g., education=(subject₁, subject₂, . . . ).

In step 260, machine learning module 122-D of virtual mentorship program 122 outputs an optimal succession of actions to the user via a user interface (e.g., user interface 132) of a user computing device (e.g., user computing device 130). In an embodiment, virtual mentorship program 122 updates the user profile to include the optimal succession of actions. In an embodiment, virtual mentorship program 122 updates the user profile to include the optimal succession of actions in order to improve future recommendations (e.g., focus on more remedial skills, suggest alternative career trajectories, etc.). In an embodiment, virtual mentorship program 122 updates the user profile to include the optimal succession of actions using a reinforcement learning model. In an embodiment, virtual mentorship program 122 stores the optimal succession of actions in a database (e.g., database 124).

In continuation of the example above, virtual mentorship program 122 creates a tuple or an array of the current state of user A (e.g., education, career, skills of user A). Simultaneously, virtual mentorship program 122 creates a metric or a score based on the marketplace analysis. The marketplace analysis assigns a quantitative metric to skills, experience, and competencies for the desired position (e.g. based on a number of times a given skill is exhibited by people currently in the desired position). Machine learning module 122-D of virtual mentorship program 122 formulates the tuple from the tuple created of the current state of user A and the metric from the metric created to explore different career trajectory steps (e.g., obtain data science qualifications, conduct online communication course, undertake an MBA, etc.). These trajectories and the impact on reward (i.e., quantitative metric describing suitability for next roles) are used to make career development recommendations to user A.

FIG. 3 depicts a block diagram of components of server 120 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as virtual mentorship program 122. In addition to virtual mentorship program 122, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and virtual mentorship program 122, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in virtual mentorship program 122 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in virtual mentorship program 122 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
identifying, by one or more processors, a position a user wishes to achieve in a request for a personalized career recommendation;
comparing, by the one or more processors, a user profile of the user to a marketplace profile for the position to determine whether there are one or more gaps in the user profile that would prevent the user from achieving the position;
responsive to determining there is a gap in the user profile, assigning, by the one or more processors, the user a task to address the gap in the user profile;
generating, by the one or more processors, a performance score using a reinforcement learning model, wherein the performance score is based on an evaluation of the user completing the task; and
responsive to updating the user profile with the performance score, generating, by the one or more processors, a recommendation using machine learning, wherein the recommendation includes a series of actions the user may take to achieve the position identified and an appropriate timeline.

2. The computer-implemented method of claim 1, further comprising:
prior to identifying the position the user wishes to achieve in the request for the personalized career recommendation, gathering, by the one or more processors, a set of information about the user; and
creating, by the one or more processors, the user profile with the set of information about the user.

3. The computer-implemented method of claim 2, wherein the set of information about the user is a set of information about a current state of the user, and wherein the set of information about the user includes at least one of a set of information about an employment history of the user, one or more relevant job skills of the user, an educational and training history of the user, one or more preferences of the user, one or more passions of the user, and one or more purposes of the user.

4. The computer-implemented method of claim 1, further comprising:
subsequent to identifying the position the user wishes to achieve in the request for the personalized career recommendation, gathering, by the one or more processors, a set of information about a state of educational requirements for the position;
gathering, by the one or more processors, a set of information about a state of a workplace;
gathering, by the one or more processors, a set of information about one or more available positions; and
creating, by the one or more processors, the marketplace profile for the position with the set of information about the state of educational requirements for the position, the set of information about the state of the workplace, and the set of information about the one or more available positions.

5. The computer-implemented method of claim 4, wherein:
the set of information about the state of educational requirements for the position includes at least one of one or more requirements of university courses, one or more demands of the university courses, and one or more ratings given to the university courses;
the set of information about the state of the workplace includes a set of information about a job market; and
the set of information about the one or more available positions includes at least one of one or more requirements of the one or more available positions and one or more profiles of one or more candidates for the one or more available positions.

6. The computer-implemented method of claim 1, wherein the assignment of the task is based on an information criterion, and wherein the information criterion is at least one of an Akaike information criterion or a Schwarz information criterion.

7. The computer-implemented method of claim 1, wherein the task includes at least one of an additional educational qualification the user needs to earn, an additional massive open online course the user needs to complete, an additional technical skill the user needs to develop, an additional soft skill the user needs to develop, an additional industry experience the user needs to gain, and a greater external eminence the user needs to achieve.

8. The computer-implemented method of claim 1, further comprising:
subsequent to generating the performance score using the reinforcement learning model, updating, by the one or more processors, the user profile to include the task completed and the performance score generated.

9. A computer program product comprising:
one or more computer readable storage media and program instructions stored on the one or more computer readable storage media, the program instructions comprising:
program instructions to identify a position a user wishes to achieve in a request for a personalized career recommendation;
program instructions to compare a user profile of the user to a marketplace profile for the position to determine whether there are one or more gaps in the user profile that would prevent the user from achieving the position;
responsive to determining there is a gap in the user profile, program instructions to assign the user a task to address the gap in the user profile;
program instructions to generate a performance score using a reinforcement learning model, wherein the performance score is based on an evaluation of the user completing the task; and
responsive to updating the user profile with the performance score, program instructions to generate a recommendation using machine learning, wherein the recommendation includes a series of actions the user may take to achieve the position identified and an appropriate timeline.

10. The computer program product of claim 9, further comprising:
prior to identifying the position the user wishes to achieve in the request for the personalized career recommendation, program instructions to gather a set of information about the user; and
program instructions to create the user profile with the set of information about the user.

11. The computer program product of claim 9, further comprising:
subsequent to identifying the position the user wishes to achieve in the request for the personalized career recommendation, program instructions to gather a set of information about a state of educational requirements for the position;
program instructions to gather a set of information about a state of a workplace;
program instructions to gather a set of information about one or more available positions; and
program instructions to create the marketplace profile for the position with the set of information about the state of educational requirements for the position, the set of information about the state of the workplace, and the set of information about the one or more available positions.

12. The computer program product of claim 9, wherein the assignment of the task is based on an information criterion, and wherein the information criterion is at least one of an Akaike information criterion or a Schwarz information criterion.

13. The computer program product of claim 9, wherein the task includes at least one of an additional educational qualification the user needs to earn, an additional massive open online course the user needs to complete, an additional technical skill the user needs to develop, an additional soft skill the user needs to develop, an additional industry experience the user needs to gain, and a greater external eminence the user needs to achieve.

14. The computer program product of claim 9, further comprising:
subsequent to generating the performance score using the reinforcement learning model, program instructions to update the user profile to include the task completed and the performance score generated.

15. A computer system comprising:
one or more computer processors;
one or more computer readable storage media;
program instructions collectively stored on the one or more computer readable storage media for execution by at least one of the one or more computer processors, the stored program instructions comprising:
program instructions to identify a position a user wishes to achieve in a request for a personalized career recommendation;
program instructions to compare a user profile of the user to a marketplace profile for the position to determine whether there are one or more gaps in the user profile that would prevent the user from achieving the position;
responsive to determining there is a gap in the user profile, program instructions to assign the user a task to address the gap in the user profile;
program instructions to generate a performance score using a reinforcement learning model, wherein the performance score is based on an evaluation of the user completing the task; and
responsive to updating the user profile with the performance score, program instructions to generate a recommendation using machine learning, wherein the recommendation includes a series of actions the user may take to achieve the position identified and an appropriate timeline.

16. The computer system of claim 15, further comprising:
prior to identifying the position the user wishes to achieve in the request for the personalized career recommendation, program instructions to gather a set of information about the user; and
program instructions to create the user profile with the set of information about the user.

17. The computer system of claim 15, further comprising:
subsequent to identifying the position the user wishes to achieve in the request for the personalized career recommendation, program instructions to gather a set of information about a state of educational requirements for the position;
program instructions to gather a set of information about a state of a workplace;
program instructions to gather a set of information about one or more available positions; and
program instructions to create the marketplace profile for the position with the set of information about the state of educational requirements for the position, the set of information about the state of the workplace, and the set of information about the one or more available positions.

18. The computer system of claim 15, wherein the assignment of the task is based on an information criterion, and wherein the information criterion is at least one of an Akaike information criterion or a Schwarz information criterion.

19. The computer system of claim 15, wherein the task includes at least one of an additional educational qualification the user needs to earn, an additional massive open online course the user needs to complete, an additional technical skill the user needs to develop, an additional soft skill the user needs to develop, an additional industry experience the user needs to gain, and a greater external eminence the user needs to achieve.

20. The computer system of claim 15, further comprising:
subsequent to generating the performance score using the reinforcement learning model, program instructions to update the user profile to include the task completed and the performance score generated.
